(19) United States
(12) Patent Application Publication
(10) Pub. No.: US 2003/0212609 A1
(43) Pub. Date: Nov. 13, 2003

(54) Method of facilitating a transaction between a buyer and at least one seller

(76) Inventors: Jeffery Blair, Folsom, CA (US); Maryann Blair, Sarasota, FL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/406,465

(22) Filed: Apr. 2, 2003

Related U.S. Application Data
(60) Provisional application No. 60/319,168, filed on Apr. 3, 2002.

(51) Int. Cl. G06F 17/60

(52) U.S. Cl. 705/26

(57) ABSTRACT

The subject invention relates generally to a method of electronically purchasing goods and services over a wide area network and more particularly to a retail method of performing, recording, and reporting commercial transactions on the Internet. Specifically, provides a method of facilitating a transaction between a buyer, at least one seller, a financial institution, and at least one collector, if required, wherein the transaction is conducted through a facilitator. The facilitator manages a commercial transaction on behalf of the parties involved and disburses payments and information appropriately, especially collecting, reporting and paying commercial transaction tax funds to the appropriate tax collection authority. Additionally, the subject invention includes a method of using a single account to manage and engage in a variety of transactions with more than one different entity on the Internet.

### RELATED APPLICATIONS

This application claims priority to U.S. Provisional Patent Application No. 60/319,168 filed Apr. 3, 2002.

### BACKGROUND OF THE INVENTION

1. Field of the Invention

The subject invention provides a method of facilitating a transaction between a buyer, at least one seller, at least one financial institution, and at least one collector if required, wherein the transaction is conducted through a facilitator over a wide area network.

2. Description of the Related Art

Various related art methods are known to facilitate a transaction between a buyer and a seller. The buyer establishes a buyer account with the seller which authenticates the buyer to the seller. The buyer selects a first product from the seller, the seller retrieves information for the first product, and the information is associated with the buyer account. Typically, the transaction is carried out over an internet. The Internet is a worldwide network of interconnected computing devices or systems and wide area networks. The internet may include the Internet plus private computing devices or systems and local or wide area networks.

The related purchasing of goods and services, or products, over the internet involves the buyer being electronically connected to the seller. The buyer is presented information via a graphical user interface provided by the seller called a web page. A collection of web pages from the same entity is known as a web site. The buyer initiates a transaction via the web page and the seller performs the functions necessary to execute the transaction. One function of the seller is to securely obtain, process, and store information provided by the buyer such as credit card and account numbers, billing and shipping information, etc. The seller may require the buyer to provide this information for each transaction. Alternately, the seller may allow the buyer to create an account, provide this information once, and access the account for a transaction by logging onto the seller web page, which requires the buyer to provide a user name and password to authenticate, authorize, and process the transaction. The seller also stores, processes, and presents information about the transaction, including commercial transactions receipts, reports, etc., in the form of a shopping cart. The shopping cart is a graphical user interface or web page that provides information to the buyer such as a total number of products chosen, a total amount of fees, and a total purchase amount. The shopping cart is known by those skilled in the art to display information during a commercial transaction.

The seller may also determine, calculate, and collect any collector fees necessary to complete the transaction, such as sales tax, VAT tax, duty tax, import/export tax, shipping, handling, transportation, cost of product, sales commission, marketing commission, etc. The seller may also make payments to the collector of these fees. Additionally, the seller electronically connects to the financial institution to authenticate, approve, process, and fund the transaction. This is usually initiated by the buyer and is in response to its decision to check out, which is an act of approving the purchase total and instructing the seller to process the transaction.

Referring to FIGS. 1 and 2, these related art methods are illustrated. FIG. 1 is a basic schematic block diagram that illustrates the movement of products, funds, and information for the related art methods. FIG. 2 is a detailed schematic flow chart illustrating the steps of the related art methods. The basic seller steps necessary to complete the transaction are: first, receiving a first buyer information set (name, address, credit card, etc.), receiving and updating a second buyer information set (product selection, quantity, total, etc.); second, transmitting transaction information to the financial institution; third, receiving information and the first set of funds from the financial institution; fourth shipping the product and providing transaction information to the buyer; and finally, if required, submitting a second set of funds to the collectors in response completing the transaction.

These related art methods are cumbersome and inefficient in many ways. For example, if the buyer wants to make a purchase from a second seller or a number of sellers, the buyer must provide name, address, credit card information, etc., over and over again. Additionally, this information now needs to be managed by the second seller. This is redundant and represents a greater risk of information theft or breach of information privacy to the buyer. Additionally, sellers incur substantial cost by maintaining collector information and making payments to the collectors. In fact, there is so much cost and complexity associated with Internet sales tax that the United States Federal Government has declared a moratorium on such tax until 2005. Further, the buyer must log onto each sellers web site individually, create an account, and execute the transaction(s). As a result, the buyer may have many user names and passwords with many sellers, which is cumbersome and represents a security risk for the buyer.

In summary, these related art methods present disadvantages to the buyer including having to provide multiple sets of information for multiple sellers, multiple log on sequences for each of the sellers, multiple sellers maintaining sensitive information increases chance of security and privacy breach, and there is no capability of generating a single report of all transactions that the buyer has with the multiple sellers. There are also disadvantages to the seller, which include the seller being responsible for security and privacy of buyer information, increased operational costs due to having to achieve these functions, increased cost due to the lack of consolidated and centralized reporting capabilities and to the lack of automated collector fee calculation, increased cost of maintaining, updating and reporting collector fees, and losing any untapped sales and marketing opportunities.

There are other disadvantages associated with the financial institutions, which include lack of consolidated, centralized transaction reporting capabilities, increased fraud risk due to the distributed nature of sensitive information, increased costs associated with Internet fraud, and untapped sales and marketing opportunities. Disadvantages to the collector include lack of automated collection and payment of collector fees, increased operational cost due to increased paperwork and decreased process efficiency, lack of consolidated, centralized transaction reporting, and less accurate or no statistical data due to decreased or no audit capability.

It would be advantageous to provide a method of facilitating a transaction between a buyer and a seller that overcomes these disadvantages, while minimally impacting existing computing devices and systems.

### BRIEF SUMMARY OF THE INVENTION AND ADVANTAGES

The subject invention provides a method of facilitating a transaction between a buyer, at least one seller, and at least one financial institution, wherein the transaction is conducted through a facilitator. The method includes the steps of establishing a buyer account for the buyer with the facilitator, authenticating the buyer to the facilitator and then retrieving information for the buyer from either one of the buyer and the buyer account in response to authenticating the buyer. Next, the buyer selects a first product from a first seller and information for the first product is retrieved. Information for the first seller is also retrieved and both the information for the first product and the information for the first seller are associated with the buyer account. Then, the buyer selects a second product from a second seller different from the first seller and information for the second product and the second seller is retrieved. Multiple products, jointly or individually, from multiple sellers may be selected. The method is characterized by associating the information for the second product and the information for the second seller with the buyer account while the information for the first product and the information for the first seller remains associated with the buyer account during a single transaction.

The subject invention further provides a method comprising the steps of establishing a buyer account for the buyer with the facilitator and authenticating the buyer to the facilitator. Next, the buyer selects a first product from a first seller and information is retrieved for the first product and for the first seller. This information is then associated with the buyer account. An amount of funds is determined to be paid to the first seller, an amount of funds is determined to be paid to the at least one collector if required, and a total amount of funds is determined due in response to determining the amount of funds to be paid to the first seller and the collector if required. The buyer information for the buyer account and a request to disperse the total amount of funds to the facilitator is transmitted to the financial institution. Next, the total amount of funds requested is received from the financial institution and the amount of funds to the first seller for the first product is paid from the total amount of funds. The method is characterized by paying the amount of funds to the collector by the facilitator independent of the buyer and the first seller based upon the information of the first product.

Accordingly, the subject invention overcomes the disadvantages associated with the related art methods. Specifically, the subject invention establishes a buyer account that allows the buyer to transact with multiple sellers. Additionally, the subject invention establishes a buyer account that allows a single buyer authentication sequence to transact with multiple sellers. Additionally, the subject invention establishes a buyer account that allows the buyer to transact with multiple sellers during a single transaction. The subject invention also determines, calculates, and collects any collector fees necessary to complete the transaction on behalf of the buyer, the seller, the financial institution, and the collector.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a schematic block diagram of a related art method of facilitating a transaction between a buyer and a seller;

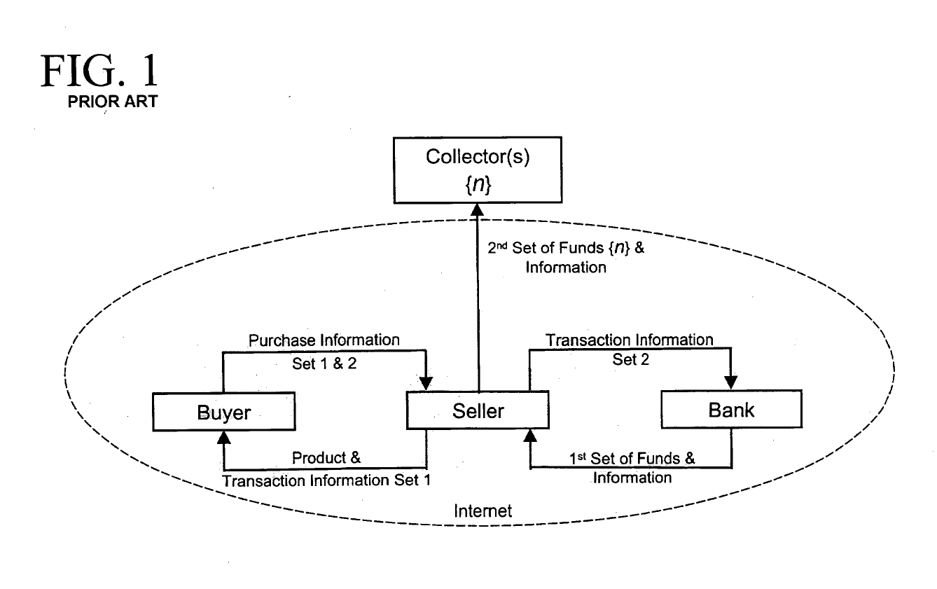

FIG. 2 is a schematic flow chart illustrating the steps of the related art method illustrated in FIG. 1;

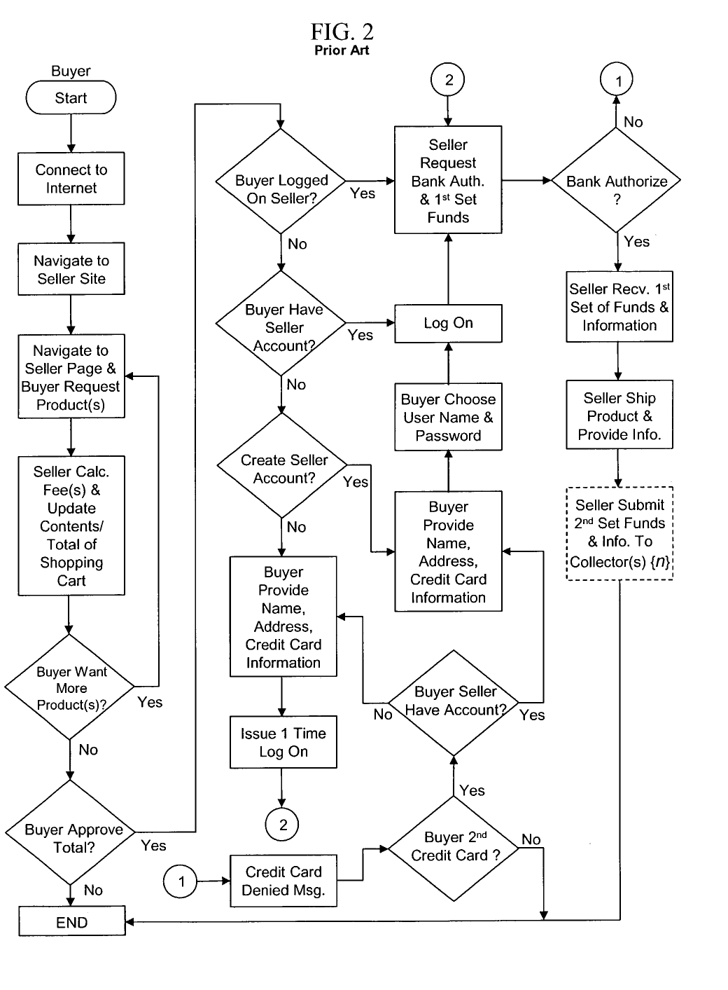

FIG. 3 is a schematic block diagram of a method of facilitating a transaction between a buyer and a seller through a facilitator according to the subject invention;

FIG. 4 is a schematic flow chart illustrating the steps of method of the subject invention illustrated in FIG. 3;

FIG. 5 is a schematic block diagram illustrating an alternate embodiment of the subject invention for facilitating a transaction between a personal seller and a buyer;

FIG. 6 is a schematic block diagram illustrating yet another embodiment of the subject invention for facilitating a transaction between a seller and a buyer whose point of sale takes place in a “brick and mortar” store;

FIG. 7 is a schematic block diagram illustrating a return transaction method according to the subject invention;

FIG. 8 is a schematic block diagram illustrating still another embodiment of the subject invention wherein the facilitator does not transmit or receive the second or third set of funds and information; and

FIG. 9 is a schematic block diagram illustrating still yet another embodiment of the subject invention for a transaction wherein the seller wants more control over bank transfers.

### DETAILED DESCRIPTION OF THE INVENTION

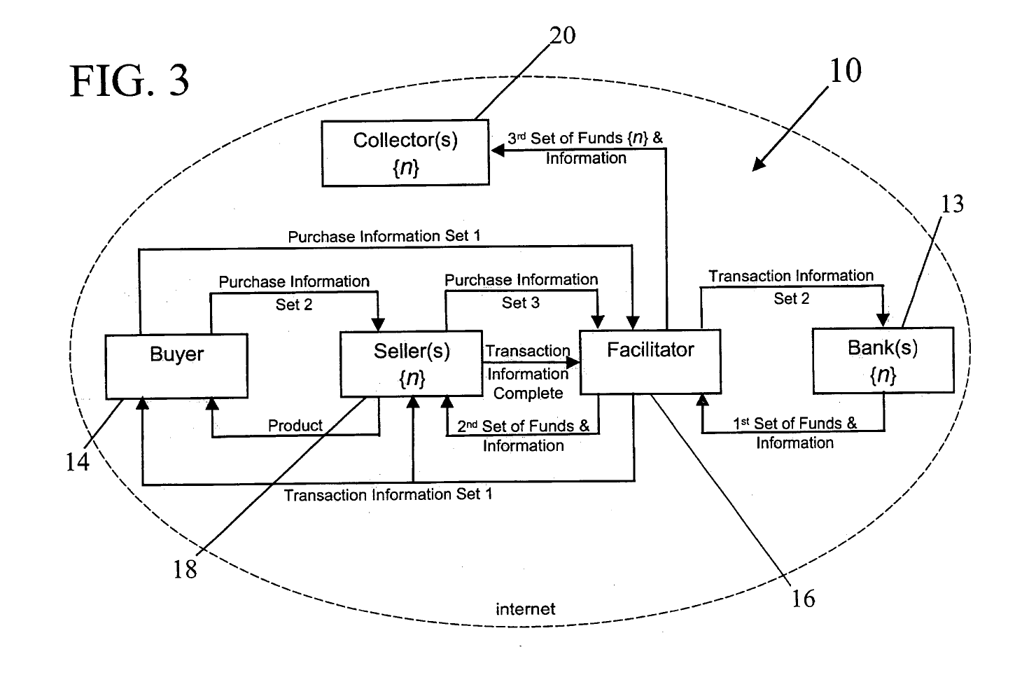

Referring to the Figures, wherein like numerals indicate like or corresponding parts throughout the several views, a method of facilitating a transaction between a buyer 14, at least one seller 18, at least one financial institution 13, and at least one collector 20, wherein the transaction is conducted through a facilitator 16 is illustrated generally at 10 in FIG. 3. The facilitator 16 represents a computing device, system, or network capable of processing and storing various data. The purpose of the facilitator 16 is to perform many of the functions normally performed by the seller 18. A user will be described below as being any one of the buyer 14, the seller 18, the financial institution 13, or the collector 20. With reference to the Figures, multiple sellers 18, collectors 20 and financial institutions 13 may be involved in the transaction according to the subject invention. As illustrated in the Figures, the reference character {n} is used to indicate that there may be multiple sellers 18, collectors 20, or financial institutions 13. More specifically, the subject invention includes a method of electronically purchasing products, electronically collecting and paying taxes and fees for the products and electronically recording and reporting transaction activities for the purchases on the internet.

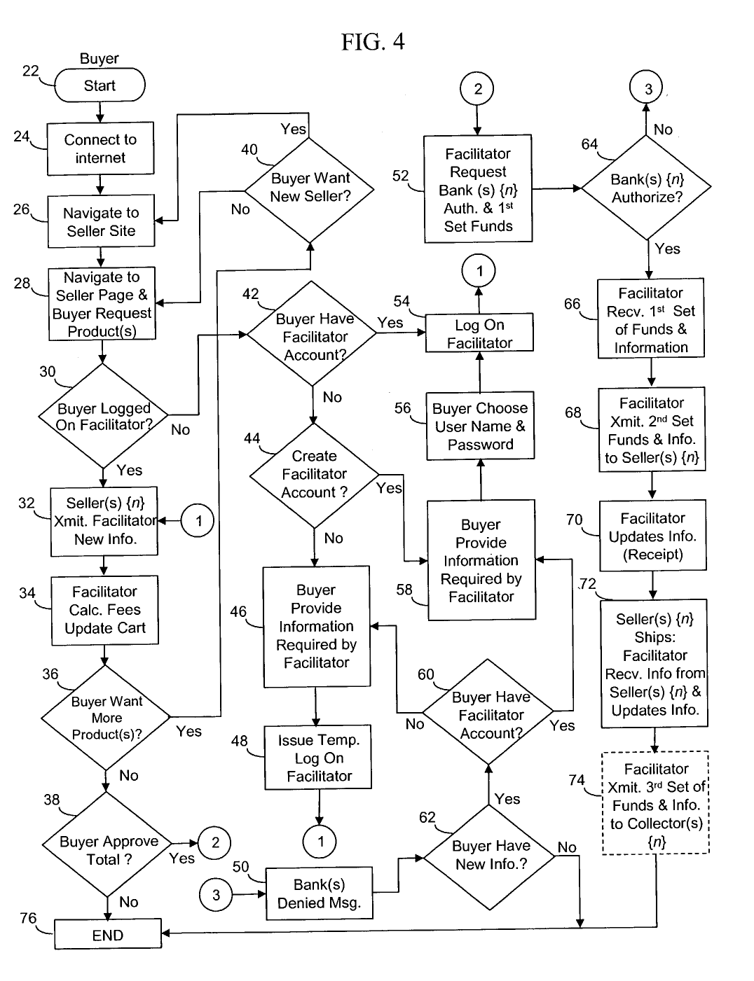

Referring to FIGS. 3 and 4, the method 10 includes the step of establishing a buyer account for the buyer 14 with the facilitator 16. In one embodiment, the buyer account is established with the facilitator 16 in steps 30, 42, and 44. The facilitator 16 then stores, maintains, and processes the information and data provided by the buyer 14 in the buyer account. In order to establish the buyer account, the facilitator 16 may need certain information from the buyer 14, as shown in steps 46, 56, and 58. For example, but in no way limiting, the facilitator 16 may need a company, individual, or entity name, a physical address, a ship to address, an e-mail address, purchase information including a credit card account number, a debit card account number and PIN code, or a financial institution account number and routing number, a user name and a password. Alternately, the facilitator 16 may require the buyer 14 to input required fields, such as the physical address and purchase information. Typically, one of the required fields is the financial institution 13 to be linked to the buyer account to disperse funds for the transaction to the facilitator 16.

The facilitator 16 may also allow the buyer 14 to establish a temporary buyer account and log on as in steps 46 and 48. The temporary buyer account may require different information, either more or less information. Specifically, the temporary buyer account requires credit card or debit card information during the purchase transaction and may require a ship to address if it is necessary to ship the product to the buyer 14. The temporary buyer account is to allow the user to make the purchase through the facilitator 16 for a single transaction. The temporary buyer account is a one time use account that requires information as described in the buyer account and successful registration of the temporary buyer account executes a one time log on to the facilitator 16 shown in step 48.

Additionally, there are three other types of accounts that may need to be established with the facilitator 16. These include a seller account, a collector account, and a financial institution account. The user of the subject invention can be registered for more than one account type. To establish either one of these accounts, basic transaction data may be required, similar to that of the buyer account. For example, but no way limiting, in order to establish the seller account, the facilitator 16 may request a company, individual, or entity name, a company, individual, or entity government identification number, a physical address, a ship to address, an e-mail address, a ship from address, a financial institution account number and routing number, seller 18 information, a collector account number and information, a user name and password. A seller account is generally of two types: a non-company seller account, also known as a personal seller account and a company seller account, also known as a corporate seller account. It is to be appreciated that various combination of this information may be required for a personal seller account and different information required for a corporate seller account.

In order to establish the collector account, the facilitator 16 may request a company, individual, or entity name, a company, individual, or entity government identification number, a physical address, an e-mail address, a financial institution account number and routing number, a payer account number and information, collector 20 information, a user name and password. To establish the financial institution account, the facilitator 16 may request a financial institution 13 name, a financial institution 13 government identification number, a physical address, an e-mail address, a financial institution account number and routing number, financial institution 13 information, a user name and password. It is to be appreciated that various combinations of this information may be required for different collectors 20 and financial institutions 13.

In general, the buyer 14 can create the buyer account by electronically connecting to the web page provided by the facilitator 16 as illustrated in steps 30, 42 and 44. The seller 18, the collector 20, and the financial institution 13 generally are required to be created by the facilitator 16 and cannot be created by the user via a facilitator 16 web page. However, in an alternate embodiment, the seller 18, the collector 20, and the financial institution 13 may connect to the facilitator 16 web page to create their respective accounts.

Financial institution accounts are generally of two types: facilitator 16 processing accounts and financial institution 13 user accounts. The facilitator 16 maintains the facilitator 16 processing accounts to transact on behalf of buyers 14, sellers 18, collectors 20 and financial institutions 13. The financial institution 13 user accounts allow for a variety of activities, but are generally provided for the transmission and reception of funds and information on behalf of the buyer 14. Additionally, other financial institution accounts can be created with the facilitator 16 to transmit and receive funds and information on behalf of seller 18 and collector 20.

The buyer 14, seller 18, collector 20, and financial institution 13 account information may be used for calculation of a tax, duty, shipping, handling, etc. However, the information associated with these accounts is generally not shared with the other entities of the transaction. This prevents any unauthorized entities from intercepting the information and preserves user information confidentiality. Therefore, it is preferable that a minimum amount of information be provided, such as shipping address or taxpayer identification number, to complete the transaction and comply with law.

After the buyer 14 has established the buyer account with the facilitator 16, the buyer 14 must be authenticated to the facilitator 16. Once the buyer 14 is authenticated, the facilitator 16 retrieves information for the buyer 14 from either one of the buyer 14 and the buyer account in response to authenticating the buyer 14. The information required for these steps will be referred to hereinafter as the first purchase information set. The first purchase information set, or purchase information set 1 illustrated in FIGS. 3 and 4, includes part 1 that is the buyer account information in step 58 and part 2 that is the buyer 14 “log on” information in step 56 required for authentication. Each part is usually provided separately, however, they may be provided simultaneously. In one embodiment, part 1 need only be provided once when creating the buyer account and part 2 is provided by the buyer 14 each time the buyer 14 wishes to transact with any of the entities. The connection between the buyer 14 and the facilitator 16 can occur in many ways, but the two most common are that of an internet direct electronic connection to the facilitator 16 web page or an internet “pass through” electronic connection from the seller's 18 web page to the facilitator's 16 web page. The internet pass through connection may also be provided by a store point of sale device, as will be described more below. In each of these cases, purchase information set 1 is exchanged solely, securely and privately between the buyer 14 and the facilitator 16. As noted in FIG. 4, the subject invention allows the buyer 14 to create the buyer account, shown in steps 44, 58, and 56, or the single transaction temporary buyer account shown in steps 44, 46, and 48 during or prior to the purchase transaction.

The facilitator 16 includes the step of logging onto the facilitator 16, shown in steps 48 and 54, which requires the log on information for the buyer 14 to authenticate the buyer 14. This log on information may include a valid user name and password, shown in step 56, or valid form of identification known to those skilled in the art such as a credit card or debit card. The facilitator 16 acquires the log on in step 54, which may take place with the facilitator 16 either via direct electronic connection or indirect electronic connection in the same manner as described in the transmission of part 1 of first purchase information set.

When the buyer 14 successfully logs onto the facilitator 16 in step 48 and 54, the facilitator 16 initiates a current computing session for the buyer 14, as shown in step 32. The computing session is current until one of the following occurs: session timeout determined by the facilitator 16, session log off determined by the buyer 14, session disconnect by electronic disconnection between the buyer 14 and the facilitator 16, or session end determined by financial institution 13. The current computing session allows the buyer 14 to transact with any entity as well as transmit and receive information from seller 18 and the facilitator 16. Referring to FIG. 4, it is noted that logging onto the facilitator 16 and can occur before navigating to the sellers 18 web page in step 26 and before the buyer 14 selects the first product in step 28.

Additionally, the seller 18, the collector 20 and the financial institution 13 may log onto the facilitator 16 in a process similar to that of the buyer 14. Specifically, they may connect to the internet in step 24, navigate to the web page of the facilitator 16 and then transmit their respective user name and password to the facilitator 16. The facilitator 16 then initiates the current computing session for the seller 18, the collector 20, or the financial institution 13. The computing session for the seller 18, the collector 20, or the financial institution 13 remains current until one of the following occurs: session timeout, session log off or session disconnect. It is generally not required that the seller 18, the collector 20, or the financial institution 13 be engaged in a current computing session in order to participate in the commercial transactions of the subject invention, however, it is necessary that the seller 18, the financial institution 13, and, in some cases collectors 20 be electronically connected to facilitator 16.

In one embodiment, after the buyer 14 has been authenticated, the buyer 14 selects a first product from the first seller 18 in step 28. It is to be appreciated that the buyer 14 may select the first product prior to authentication. It is also to be appreciated that the term product can refer to a single product and several products and that the term product can refer to a single service and several services. In response to selecting the first product, information for the first product is retrieved and is referred to hereinafter as a second purchase information set, or purchase information set 2. Typically the second purchase information set includes the product number, price and quantity, etc. In one embodiment, the facilitator 16 receives the second purchase information set from the buyer 14 who received it from the seller 18 in step 32. In another embodiment, the buyer 14 provides the second purchase information set to the seller 18, who then provides this information to the facilitator 16. In this embodiment, the seller 18 provides the second purchase information set to the facilitator 16 in a third purchase information set, or purchase information set 3. In other words, the facilitator 16 retrieves information for the first seller 18, as described above. The third purchase information set includes the second purchase information set plus information specific to the seller 18. Additionally, either one of the second purchase information set and the third purchase information set includes an amount of funds to be paid to the first seller 18, an amount of funds to be paid to the at least one collector 20, and an amount of funds to be paid to the facilitator 16.

The facilitator 16 receives the information and then associates the information for the first product and the information for the first seller 18 with the buyer account in step 34. Associating the information with the buyer account includes the step of processing the buyer 14 information, the seller 18 information, the collector 20 information and the financial institution 13 information in order to calculate any taxes, fees etc. and then updates the buyer account in step 34. Those skilled in the art will recognize this procedure as being associated with a shopping cart. The shopping cart, as used on the internet, is a graphical user interface, such as a web page or user viewing method or both, provided by either one of the seller 18 or the facilitator 16 to the buyer 14 so that the buyer 14 can transmit and receive information about the purchase.

Next, the buyer 14 either navigates to a web page of a second seller 18 or a subsequent web page for the first seller 18 in step 40. In the case of a second seller, the buyer 14 selects a second product from the second seller 18 different from the first seller 18. The second seller 18 would have previously established their account in a similar manner to that described above for the first seller 18. Further, after selecting the second product, information for the second product is retrieved as described above from either the second seller 18 or the facilitator 16 again shown in step 32. In retrieving the information for the second product, the facilitator 16 or the seller 18 determines an amount of funds to be paid to the second seller 18, an amount of funds to be paid to the at least one collector 20, and an amount of funds to be paid to the facilitator 16. Next, the facilitator 16 retrieves information for the second seller 18, as described above for the first seller 18.

The method is characterized by associating the information for the second product and the information for the second seller 18 with the buyer account while the information for the first product and the information for the first seller 18 remains associated with the buyer account during a single transaction again in step 34. After the second product has been associated with the buyer account, a first transaction information set, or transaction information set 1 is displayed to the buyer 14 having the information for the first product and the first seller 18 and the information for the second product and the second seller 18. The first transaction information set is also displayed to the sellers 18 however each seller 18 sees only information pertaining to the product which it is selling. The first transaction information set is displayed to the buyer 14 in the shopping cart in step 34. The shopping cart is not provided by, nor specific to the seller 18. Rather, the facilitator 16 provides the shopping cart. The shopping cart allows the buyer 14 to select products from many sellers 18 and then transact with these many sellers 18, collectors 20, and financial institutions 13 simultaneously upon final execution, or check out as used in the art, of the purchase transaction. This type of shopping cart provides the buyer 14 with information from all of the sellers 18 in a single itemized list or report.

The first transaction information set is calculated and updated in response to the buyer 14 selecting additional products from the same or different sellers 18 shown in steps 36 and 40. If there are additions or subtractions or both, the second purchase information set is again provided by the buyer 14, the third purchase information set is again provided by the seller 18 and the first transaction information set is again updated by the facilitator 16. This process repeats until the buyer 14 approves the total in step 38 and contents of the facilitator 16 shopping cart thus initiating the purchase transaction execution, or check out. As described herein alternative embodiments of the subject invention may alter this sequence.

Once the buyer 14 has initiated check out, a total amount of funds due is determined in response to determining the amount of funds to be paid to the first seller 18, the second seller 18, the at least one collector 20, and the facilitator 16. After the total amount of funds has been determined, the facilitator 16 transmits the buyer 14 information from the buyer account to the linked financial institution 13 and transmits a request to the financial institution 13 to disperse the total amount of funds to the facilitator 16 in step 52. The total amount of funds and the request are described herein after as a second transaction information set, or transaction information set 2. The total amount of funds equals the shopping cart total. The second transaction information set may also include the first purchase information set, the second purchase information set, and the third purchase information set, or any additional information the financial institution 13 may require to process the transaction.

The subject method may include the step of receiving a denial to disperse the total amount of funds from the financial institution 13 to the facilitator 16 in steps 64 and 50. In response to receiving the denial, the facilitator 16 updates the first transaction information set to indicate the denial of the total amount of funds, preferably in the shopping cart. The buyer 14 is then given the opportunity to link a different financial institution 13 to the buyer account in response to updating the first transaction information set with the denial of the total amount of funds in step 62. When the transaction is denied, the financial institution 13 informs the facilitator 16, who notifies the buyer 14 and seller 18 of the denial in step 50. The buyer 14 is then given the opportunity to update the first purchase information set by providing new credit card or other information in steps 62, 60, and 58. The buyer 14 is also given the opportunity to end the transaction, shown in step 76. In linking a different financial institution 13 to the buyer account, it is generally not required that the buyer 14 choose another user name and password, step 56, or re-log onto the facilitator 16, step 54, as the computing session is already current. Once the buyer 14 updates the first purchase information set, the buyer 14 is then asked to re-initiate the check out process in step 38 after given the opportunity to once again update the shopping cart in steps 32, 34, and 36.

If the financial institution 13 grants the request, the facilitator 16 receives the total amount of funds from the financial institution 13 and updates the first transaction information set to indicate the received total amount of funds in step 66. If financial institution 13 authorizes the transaction in step 64, the financial institution 13 then transmits the total amount of funds to the facilitator 16 in step 66. From the total amount of funds, the facilitator 16 pays the amount of funds to the first seller 18 for the first product and pays the amount of funds to the second seller 18 for the second product in step 68. The first seller 18 and the second seller 18 may be paid independently of each other.

More specifically, a first set of funds equal to the shopping cart total and information, such as transaction identifier numbers, etc. is transmitted to the facilitator 16. The facilitator 16 then transmits a second set of funds and information to the sellers 18 in step 68. The second set of funds and information contain funds equal to the first set of funds minus all collector 20 fees and minus any processing fees of the facilitator 16. The second set of funds and information also contain, among other information, information specific for the seller 18 and information generally for the seller 18 that identify the specific product the seller 18 has sold as well as the specific transaction identifier for the seller 18. The second set of funds and information may or may not be provided solely to seller 18. Upon transmission of the second set of funds and information in step 68, the facilitator 16 updates the first transaction information set in step 70; i.e., updates the shopping cart status. This informs both the buyer 14 and seller 18 with the status of the transaction.

In one embodiment, the seller 18 then ships the products, as shown in step 72, and notifies the facilitator 16 of any shipping information, receipt information and a status of the transaction in step 72. The facilitator 16 provides the receipt, shipping and other information to the buyer 14 either through the first transaction information set or directly from the seller 18 in the form of a web page or hyper-link that the buyer 14 can navigate to directly to retrieve information from the seller 18. When received by the facilitator 16, the first transaction information set is updated so the buyer 14 can easily retrieve information for the transaction in steps 70 and 72. The buyer 14 can easily retrieve and query the information by navigating to the facilitator 16 web page and logging onto the facilitator 16 in step 54 and requesting the appropriate reporting query from the options provided by a reporting utility of the facilitator 16. It is noted that the facilitator 16 will, after some time has lapsed, store completed purchase transaction information in a separate location and not the shopping cart in order to provide more efficient information management and reporting.

The subject method also includes the step of paying the amount of funds to the at least one collector 20 based upon the information for the first product and the first seller 18 and the information for the second product and the second seller 18 in step 74. The facilitator 16 maintains a database of collector 20 information. The collector 20 or the facilitator 16 or both updates this information regularly. Updates occur either automatically through electronic connection of the collector 20 to the facilitator 16 or manually through the collector 20 logging onto the facilitator 16 in step 54 and transmitting updated information or both. This information contains, by way of example, and not of limitation, the latest tax table information for the collection of sales tax, duty, VAT, etc., the latest shipping rate tables for the collection of freight fees, etc. and the latest information for the collection of any other third party fees.

The facilitator 16 transmits a third set of funds, i.e., the amount of funds to be paid the at least one collector 20, and information to the at least one collector 20 in step 74. There may be multiple collectors 20 per seller 18. The third set of funds and information contain funds collected for the collectors 20 equal to the amount determined by the facilitator 16 in step 34 as a result of data and information provided by collectors 20 during, or subsequent to, collector account creation. The third set of funds and information also contain information regarding each buyer 14 and seller 18, including transaction identification numbers, etc. In one embodiment, these funds are transmitted at the time of the transaction. In another embodiment, these funds and information are usually not transmitted at the time of the transaction but, rather are consolidated and reconciled at a later date.

In paying the collectors 20, the facilitator 16 may need to determine a location for the buyer 14 from the buyer account. This may be a required field for the buyer 14 to input when establishing the buyer account in step 58. Based upon the location of the buyer 14 and the updated information from the collector 20, the facilitator 16 may pay a tax to a tax collector 20 based on the first amount of funds paid for the first product and based on the second amount of funds paid for the second product in response to determining the location of the buyer 14. Additionally, the facilitator 16 may pay shipping costs to a shipment collector 20 for shipping the first product and the second product from the first seller 18 and the second seller 18 to the buyer 14.

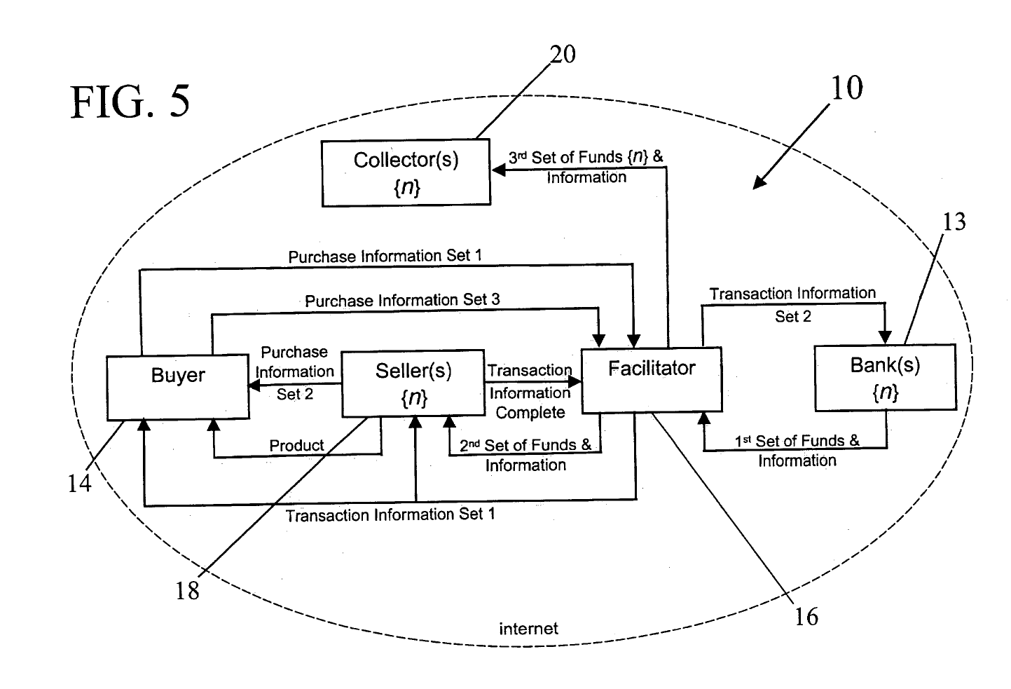

Referring to FIG. 5, an alternate embodiment of the subject invention is illustrated for facilitating a transaction between a personal seller 18 interacting with the buyer 14 for a single purchase transaction. This seller 18 may not have a seller 18 web page or physical store or both. By way of example, and not of limitation, this situation is common for “person-to-person” purchase transactions, e.g. situations when the buyer 14 wishes to purchase directly from a seller 18 after being brought together by a third party such as a newspaper, internet directory or listing service or an internet auction service.

A special type of seller account designated as a personal seller account is created with the facilitator 16. The personal seller account does not need to be created by the facilitator 16 as the seller account typically does. A personal seller account can be created by the user by registering the necessary information with the facilitator 16 in the same way as the buyer account, specifically, via an electronic connection to the facilitator 16 and typically by means of the facilitator's 16 web page. The creation of a personal seller account first requires a current buyer account, thus, the first purchase information set remains, as described above. Once the user performs a successful log onto the facilitator 16 in step 54, the user then provides additional information specific to the requirements of the personal seller account, such as where to deposit any sale proceeds.

Next, the facilitator 16 initiates the capabilities of the personal seller account. In this a person-to-person purchase transaction, the seller 18, i.e., the user of the personal seller account, provides the buyer 14 with the second purchase information set. This information includes, but is not limited to, the product information, the total price, with or without the amount to be paid to the collector 20, depending on whether the seller 18 plans to pay the fees themselves or have the facilitator 16 pay them, and the sellers 18 user name as registered with the facilitator 16. The second purchase information set may be provided to the buyer 14 via electronic mail or some other form of communication by the seller 18.

Next, the buyer 14 provides the facilitator 16 with the third purchase information set, which includes the details of the transaction, including the payment instructions, terms of the sale and the necessary information from the second purchase information set. The facilitator 16 then updates the first transaction information set, including the calculation of any collector 20 fees as instructed by the buyer 14 and transmits the second transaction information set to the financial institution 13. Upon receiving the first set of funds and information, the facilitator 16 transmits the second set of funds and information to the seller 18 and the third set of funds and information to the collector 20, if required or if desired or both. As set forth above, the amount paid to the collector 20 may occur at a time after completion of the transaction or simultaneously.

If in the terms of the sale the buyer 14 waits to pay the seller 18 until after the product is received, the facilitator 16 includes zero funds with the first set of funds and information. The facilitator 16 then updates the first transaction information set and the seller 18 ships the product. Once shipped, the seller 18 notifies the facilitator 16 that the transaction is complete, which includes, but is not limited to, information about the shipment, such as tracking information. The facilitator 16 then again updates the first transaction information set so the buyer 14 has the latest transaction information. If the terms of sale were to wait to pay seller 18, the facilitator 16 automatically provides payment to seller 18 once product delivery has been confirmed, as provided by information supplied by the shipper and the specified product inspection term as defined by the terms of sale has lapsed. This payment then completes the transmission of the second set of funds and information.

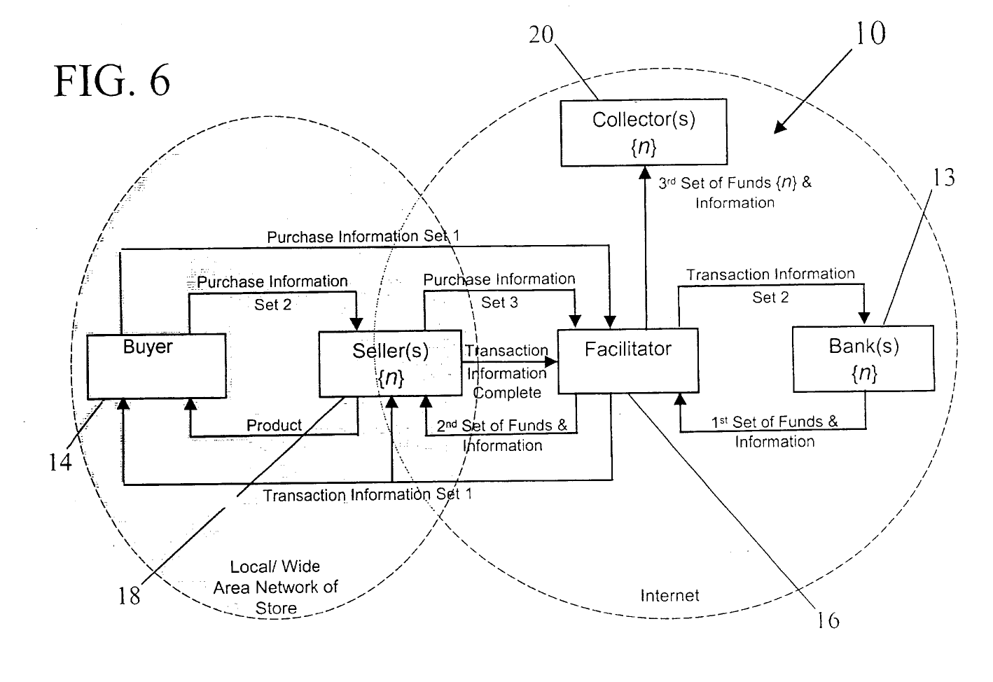

Referring to FIG. 6, yet another embodiment of the subject invention is illustrated for facilitating a transaction between the seller 18 of a physical store, also known as “brick and mortar” store, and the buyer 14 for a single purchase transaction. The electronic connections between the buyer 14 and the seller 18 now take place via the store local network or wide area network. A point of sale device or check out terminal is connected to the store local network which is connected to the internet. The buyer 14 is not required to visit the seller's 18 web page, because the buyer 14 is physically present in the store. Instead of the buyer 14 logging onto the facilitator 16, it occurs automatically during the buyer 14 check out. Specifically, the first purchase information set is received by the facilitator 16 during the check out.

First, the store clerk checks the identification of the buyer 14 and then electronically scans a credit card or debit card of the buyer 14 i.e., the first purchase information set, into the point of sale device. The point of sale device solely, securely and privately transmits the first purchase information set to the facilitator 16. Authentication of the buyer 14 takes place automatically as a result of the trust relationship the facilitator 16 has with the brick and mortar seller 18 and the presence of the credit or debit card as confirmed by the information transmitted by the point of sale device. The buyer 14 automatically logs onto the facilitator 16 in step 54 thus authorizing the buyer 14 and starting a current computing session. The session end will take place once the financial institution 13 instructs the facilitator 16 that the transaction is complete, i.e., receiving the total amount of funds or the first set of funds and information. If the buyer 14 does not have a current buyer account with the facilitator 16, the transaction will take place by means of the temporary buyer account.

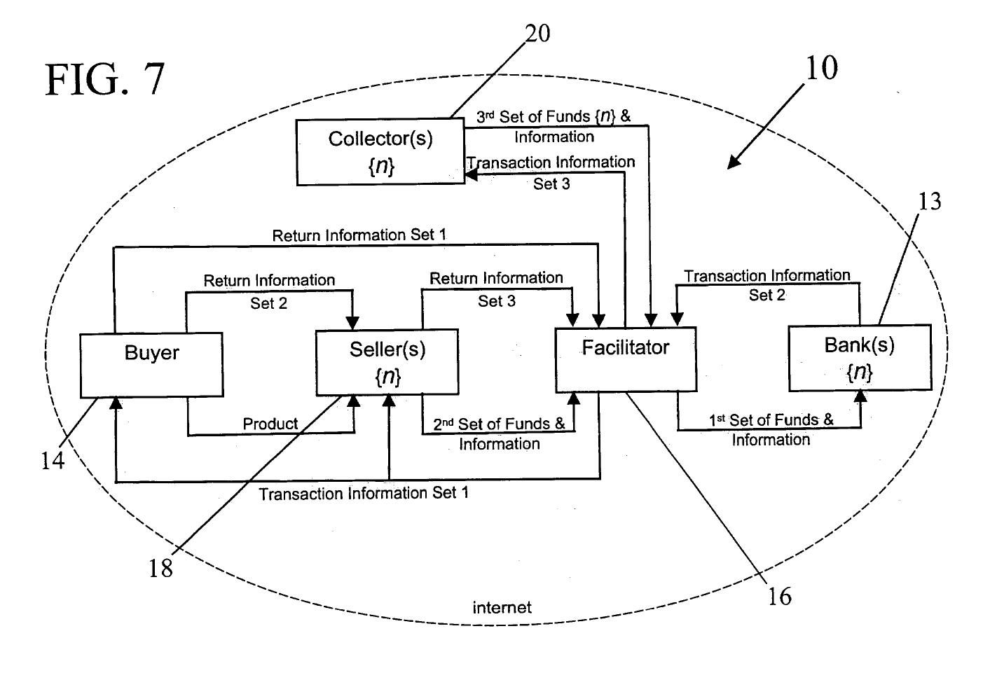

Referring to FIG. 7, a method of facilitating a return transaction according to the subject invention in illustrated. The method is essentially the reverse of the steps described above and shown in FIGS. 3 and 4. The return method begins with the buyer 14 providing a first return information set, or return information set 1, to the facilitator 16. The first return information set includes the same information as the first purchase information set shown in FIG. 3. As before, part 1 does not need to be provided again by buyer 14, if buyer 14 has a current buyer account. If the buyer 14 does not have a current buyer account or if the purchase transaction was completed with a temporary buyer account, the buyer 14 must provide the required facilitator 16 information in step 46 again. As before, a buyer 14 with a current account must provide part 2 information to log onto the facilitator 16 in step 54. The facilitator 16 may issue a temporary log on to the facilitator 16 in step 48 when the temporary buyer account is initiated for buyer 14. Next the buyer 14 navigates to the seller's 18 web page and transmits a second return information set, or return information set 2. The second return information set includes the product information and the purchase transaction identification number. If the seller 18 allows the product to be returned, the seller 18 then transmit a third return information set to the facilitator 16. The third return information set, or return information set 3, includes information from the second return information set as well as information from the seller 18 including, but not limited to, the return quantity, product number, product credit price, restock fee, return authorization number, etc.

When the facilitator 16 receives this information, the facilitator 16 then confirms the transaction identification number matches a valid product purchase and then updates the first transaction information set, or transaction information set 1, which informs the buyer 14 and the seller 18 of the details of the return. If the transaction identification information is not valid, the facilitator 16 updates the first transaction information set indicating to the buyer 14 and the seller 18 that the transaction will end in step 76 unless the buyer 14 can provide valid information. Once a valid return authorization is issued, the buyer 14 ships the return product to seller 18. When received, the seller 18 inspects the product, approves, or disapproves the product return transaction. If disapproved, the seller 18 returns the product to the buyer 14. If approved, the facilitator 16 is notified accordingly by transmitting the second set of funds and information back to the facilitator 16. The second set of funds and information includes funds equal to the return authorization amount, or no funds if disapproved, and information about the return from seller 18. The facilitator 16 then updates the first transaction information set and transmits a third transaction information set, or transaction information set 3. The third transaction information set includes information about the return product transaction and the request for transmittal of the third set of funds and information from collector 20. Collector 20 then transmits the third set of funds and information to the facilitator 16. The third set of funds and information contain funds equal to the corresponding collector 20 funds from the original purchase transaction. Alternately, the collector 20 may be reconciled at a later date to improve efficiency as previously discussed. Finally, the return transaction ends after the facilitator 16 transmits the first set of funds and information to the financial institution 13, then receives the financial institution 13 conformation transmission of second transaction information set, or transaction information set 2, and updates the first transaction information set. It is noted that the first set of funds and information contain funds that may or may not equal the second set of funds plus the third set of funds plus the original purchase transaction facilitator 16 funds.

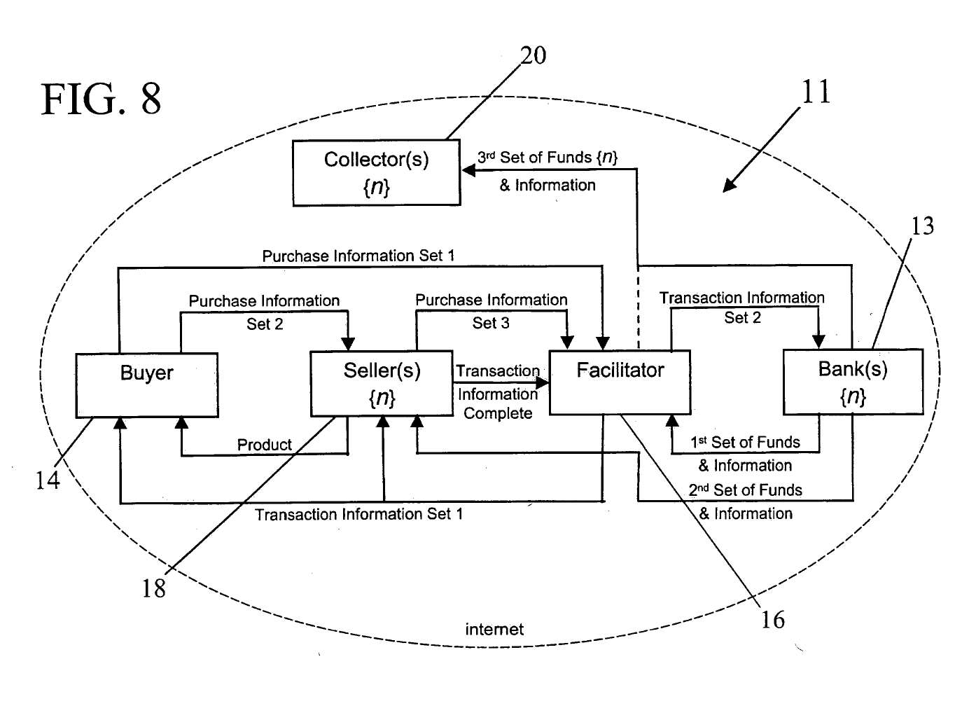

Referring to FIG. 8, still another embodiment is shown having a method generally as 11. In this embodiment, the facilitator 16 does not transmit or receive the second or third set of funds and information. This allows the seller 18 to manage the financial institution 13 transfers without using the facilitator 16. The seller 18 and the at least one collector 20 receive the second and third set of funds and information, respectively, directly from the financial institution 13 in response to receiving instructions in the second transaction information set from the facilitator 16. The dashed line illustrates that the facilitator 16 may or may not transfer the third set of funds and information to the collector 20. Therefore, the first set of funds and information include funds equal to the service fees of the facilitator 16 only, unless the facilitator 16 is designated to pay the collector 20. In which case, the first set of funds and information also include the third set of funds and information.

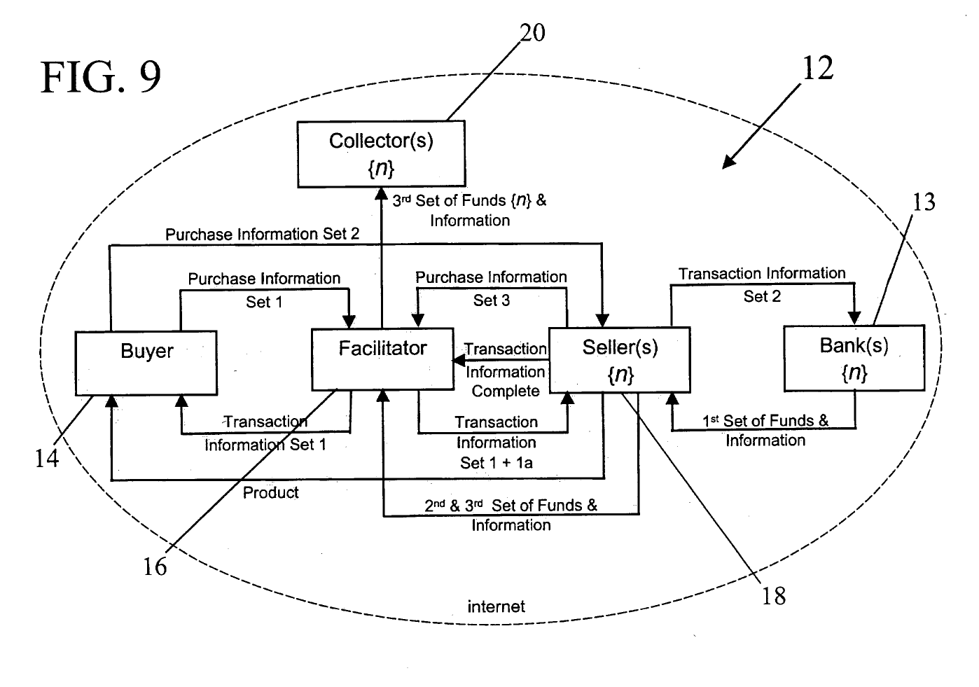

With reference to FIG. 9, still yet another embodiment is shown for a method of facilitating a transaction wherein the seller 18 wants more control over financial institution 13 transfers generally shown at 12. The seller 18 instructs the financial institution 13 to initiate funds transfer, i.e., the second transaction information set, thus allowing the seller 18 to maintain and manage their own credit card merchant financial institution accounts. This functionality typically provides easier integration of the subject invention to the seller's 18 existing computing devices and systems. In this embodiment, the facilitator 16 provides the first transaction information set part 1 and part 1a, or transaction information set 1 plus 1a, to the seller 18. The first transaction information set part 1a contains the first purchase information set parts 1 and 2 in an encrypted form. This embodiment provides a way to isolate this information from the seller 18 so the seller 18 does not have direct access to the buyer 14 confidential information. The encrypted first purchase information set is transmitted to the financial institution 13 with the second transaction information set. The financial institution 13 decrypts the information when received. The financial institution 13 then disperses the total amount of funds, but may separate out the first, the second, and the third sets of funds.

The subject invention provides many advantages over the related art methods which include isolating the buyer 14 financial and personal information from seller 18 thus improving security and deterring fraud, allowing a single log on sequence to transact with multiple sellers 18, allowing the single log on sequence to simultaneously transact with the multiple sellers 18. The subject invention also provides information to the buyer 14 concerning all pending transactions with each of the seller 18 in a single report and allows the buyer 14 simultaneously complete multiple transaction with multiple sellers 18 via a single check out command. The subject invention also generates a single itemized report showing account activity for some or all activities specific to the account. The subject invention also reduces the seller 18 cost by replacing their electronic commerce transaction-processing system thus improving the seller 18 efficiency and reducing risk of fraud. Further, the subject invention allows automatic collection, calculation, processing, and payment of collector 20 fee funds, which is based on information provided by the entities involved in the transaction.

The subject invention further provides advantages to the buyer 14, which include only providing one set of information for many sellers 18, one account for many sellers 18, one log on sequence for many sellers 18, the facilitator 16 keeps all sensitive information thus improving security and privacy when performing the transaction on the internet, and having a consolidated, centralized transaction reporting capability. Additionally, the subject invention provides advantages to the seller 18, which include having reduced security risks by not having to receive, process, or maintain customer purchasing information, having reduced operational costs by not having to operate their own systems and maintaining a consolidated and centralized reporting capabilities, having reduced operational costs due to the maintaining, updating, and reporting and automated payment capabilities to the collectors 20, and potential of increased sales and marketing opportunities due to the new sales channel that results from client base of purchasers who transact using the subject invention.

The financial institution 13 receives the advantages of a consolidated, centralized transaction reporting capability, having reduced fraud risk due to the improved purchasing and privacy capabilities and costs of fraud, and potential of increased sales and marketing opportunities due to the new sales channel that results from client base of purchasers who transact using the subject invention. The advantages that the collector 20 receives include automated collection of tax and fees, reduced operational cost due to reduced paperwork and increased process efficiency, consolidated, centralized transaction reporting, more accurate statistical data, and increased audit capability.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A method of facilitating a transaction between a buyer, at least one seller, and at least one financial institution, wherein the transaction is conducted through a facilitator, said method comprising the steps of:
establishing a buyer account for the buyer with the facilitator;
authenticating the buyer to the facilitator;
retrieving information for the buyer from either one of the buyer and the buyer account in response to authenticating the buyer;
selecting a first product from a first seller;
retrieving information for the first product;
retrieving information for the first seller;
associating the information for the first product and the information for the first seller with the buyer account;
selecting a second product from a second seller different from the first seller;
retrieving information for the second product;
retrieving information for the second seller;
said method characterized by associating the information for the second product and the information for the second seller with the buyer account while the information for the first product and the information for the first seller remains associated with the buyer account during a single transaction.

2. A method as set forth in claim 1 wherein the step of retrieving information for the first product further comprises the step of determining at least one of an amount of funds to be paid to the first seller and an amount of funds to be paid to the facilitator.

3. A method as set forth in claim 2 wherein the step of retrieving information for the second product further comprises the step of determining at least one of an amount of funds to be paid to the second seller and an amount of funds to be paid to the facilitator.

4. A method as set forth in claim 3 further comprising the step of determining a total amount of funds due in response to determining the amount of funds to paid to the first seller, the second seller, and the facilitator.

5. A method as set forth in claim 4 further comprising the step of displaying a first transaction information set having the information for the first product and the first seller and the information for the second product and the second seller to allow one of the buyer and the seller to review a status of the transaction.

6. A method as set forth in claim 5 wherein the step of establishing the buyer account is further defined as linking the financial institution to the buyer account to disperse funds for the transaction to the facilitator.

7. A method as set forth in claim 6 further comprising the steps of transmitting buyer information from the buyer account to the linked financial institution and transmitting a request to the financial institution to disperse the total amount of funds to the facilitator.

8. A method as set forth in claim 7 further comprising the step of receiving a denial to disperse the total amount of funds from the financial institution to the facilitator and further comprising the step of updating the first transaction information set to indicate the denial of the total amount of funds.

9. A method as set forth in claim 8 further comprising the step of linking a different financial institution to the buyer account in response to updating the first transaction information set with the denial of the total amount of funds.

10. A method as set forth in claim 7 further comprising the step of receiving the total amount of funds from the financial institution and further comprising the step of updating the first transaction information set to indicate the received total amount of funds.

11. A method as set forth in claim 10 further comprising the step of paying the amount of funds to the first seller for the first product from the total amount of funds and paying the amount of funds to the second seller for the second product from the total amount of funds.

12. A method as set forth in claim 11 wherein the step of paying the first seller and wherein the step of paying the second seller are further defined as occurring independently of each other.

13. A method as set forth in claim 12 further including at least one collector and further comprising the step of paying an amount of funds to the collector based upon the information for the first product and the first seller and the information for the second product and the second seller.

14. A method as set forth in claim 13 further comprising the step of determining a location for the buyer from the buyer account.

15. A method as set forth in claim 14 wherein the step of paying the collector is further defined as paying a tax to a tax collector by the facilitator based on the first amount of funds paid for the first product and based on the second amount of funds paid for the second product in response to determining the location of the buyer.

16. A method as set forth in claim 15 wherein the step of paying the collector is further defined as paying shipping costs to a shipment collector by the facilitator for shipping the first product and the second product from the first seller and the second seller to the buyer.

17. A method as set forth in claim 16 further comprising the step of updating the first transaction information set to indicate payments from the facilitator to the first seller, the second seller, and the collector and to indicate the status of the transaction.

18. A method of facilitating a transaction between a buyer, at least one seller, a financial institution, and at least one collector, wherein the transaction is conducted through a facilitator, said method comprising the steps of:
establishing a buyer account for the buyer with at least one of the facilitator and the seller;
authenticating the buyer to at least one of the facilitator and the seller;
selecting a first product from a first seller;
retrieving information for the first product;
retrieving information for the first seller;
associating the information for the first product and the information for the first seller with the buyer account;
determining an amount of funds to be paid to the first seller;
determining an amount of funds to be paid to the at least one collector;
determining a total amount of funds due in response to determining the amount of funds to paid to the first seller and the collector;
transmitting buyer information from the buyer account to the financial institution and transmitting a request to the financial institution to disperse the total amount of funds to the facilitator;
receiving the total amount of funds requested from the financial institution;
paying the amount of funds to the first seller for the first product from the total amount of funds;
said method characterized by paying the amount of funds to the collector by the facilitator independent of the buyer and the first seller based upon the information of the first product.

19. A method as set forth in claim 18 further comprising the step of maintaining a database of the amount of funds paid to the collector by the facilitator from the buyer associated with the buyer account.

20. A method as set forth in claim 19 further comprising the step of determining a location for the buyer from the buyer account.

21. A method as set forth in claim 20 wherein the step of paying the collector is further defined as paying a tax to a tax collector based on the first amount of funds paid for the first product in response to determining the location of the buyer by the facilitator independent of the buyer and the first seller.

22. A method as set forth in claim 21 wherein the step of paying the collector is further defined as paying shipping costs to a shipment collector by the facilitator for shipping the first product from the first seller to the buyer.

23. A method as set forth in claim 18 wherein the step of paying the amount of funds to the first seller is further defined as paying the amount to the first seller after the buyer has received the first product.
